(19) United States
(12) Patent Application Publication
(10) Pub. No.: US 2006/0219063 A1
(43) Pub. Date: Oct. 5, 2006

(54) Sprocket wrench

(75) Inventor: Masatoshi Takamatsu, Sakai (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/412,978

(22) Filed: Apr. 28, 2006

(51) Int. Cl. B25B 13/52

(52) U.S. Cl. 81/65.2; 81/64

(57) ABSTRACT

A chain sprocket wrench includes a handle portion, a bar portion and an elongated flexible sprocket engaging portion. The bar portion extends from the handle portion and includes a tool end section. The elongated flexible sprocket engaging portion has a first end and a second end. The first end of the elongated flexible sprocket engaging portion is fixed to the tool end section. A magnetic part is fixed to the second end of the elongated flexible sprocket engaging portion.

### BACKGROUND OF THE INVENTION

1. Field of the Invention

This invention generally relates to sprocket wrench. More specifically, the present invention relates to sprocket wrench that is configured to retain portions of the wrench in a tool storage orientation when not in use.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle.

Tools used to repair and customize bicycles are also constantly being improved. One such tool is the sprocket wrench that is used to install and remove sprocket sets from a rear wheel hub. Typically such sprocket wrenches include a main body and a chain link section that has a first end and a second end. The first end of the chain link section is typically fixed to one end of the main body of the sprocket wrench. The second end is typically a free end that is unattached and moves freely with respect to the main body of the sprocket wrench. When in use, the chain link section is wrapped at least part way around one sprocket of the sprocket set and the main body of the sprocket wrench is used as a lever to apply force to the sprocket set. When not in use, the chain link section is typically laid along side the main body of the sprocket wrench, but can get caught by other tools if laid loose in a tool box. Some sprocket wrenches include a spring that can be attached to the chain link section in order to retain the chain link section in a tool storage orientation along side the main body of the sprocket wrench. However, the spring is an extra part that may come loose and be lost.

In view of the above, it will be apparent to those skilled in the art from this disclosure that there exists a need for an improved sprocket wrench that retains the chain link section in place conveniently when not in use without the use of a spring. This invention addresses this need in the art as well as other needs, which will become apparent to those skilled in the art from this disclosure.

### SUMMARY OF THE INVENTION

One object of the present invention is to provide a sprocket wrench that is configured to retain portions of the wrench in a tool storage orientation when not in use.

Another object of the present invention is to provide a sprocket wrench with a chain link section of the sprocket wrench that is easily and simply retained in a tool storage orientation when not in use.

The foregoing objects can basically be attained by providing the chain link section with a magnet that holds the chain link section against a bar portion of the sprocket wrench when not in use.

In accordance with one aspect of the present invention, a chain sprocket wrench includes a handle portion, a bar portion and an elongated flexible sprocket engaging portion. The bar portion extends from the handle portion and includes a tool end section. The elongated flexible sprocket engaging portion has a first end and a second end. The first end is fixed to the tool end section, and a magnetic part is fixed to the second end of the elongated flexible sprocket engaging portion.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of a chain sprocket wrench that includes a sprocket engaging portion in accordance with the present invention;

FIG. 2 is a side view of a bicycle wheel having a sprocket set with the chain sprocket wrench depicted in FIG. 1 with the sprocket engaging portion partially wrapped around a sprocket of the sprocket set in a tool usage orientation, in accordance with the present invention;

FIG. 3 is a front view of the chain sprocket wrench showing the sprocket engaging portion in a tool storage orientation in accordance with the present invention;

FIG. 4 is another front view of the chain sprocket wrench similar to FIG. 3, showing the sprocket engaging portion in the tool usage orientation in accordance with the present invention;

FIG. 5 is a side view of the chain sprocket wrench in accordance with the present invention;

FIG. 6 is a perspective view of a portion of the chain sprocket wrench showing an end of the sprocket engaging portion with a magnet holder and a magnet in accordance with the present invention; and

FIG. 7 is an exploded perspective view of the magnet holder and the magnet in accordance with the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

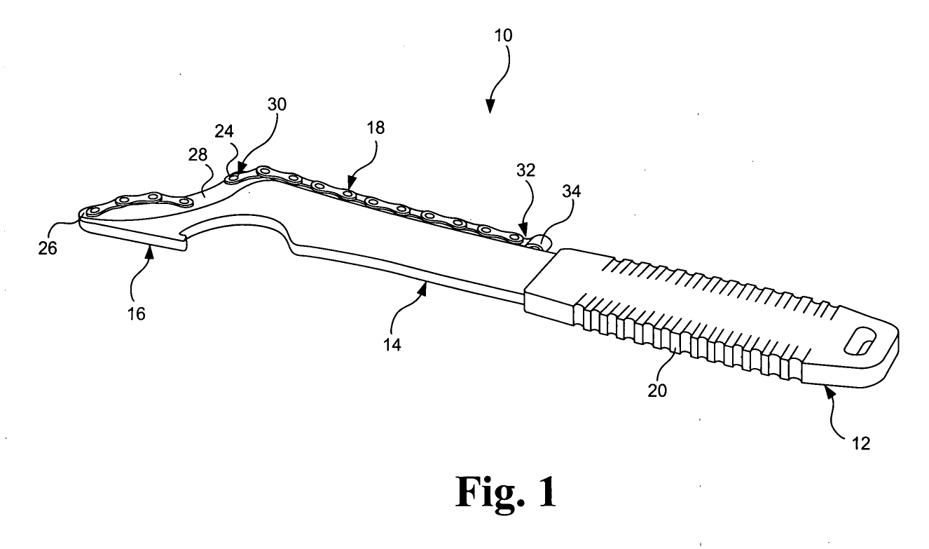

Referring initially to FIG. 1-4 a chain sprocket wrench 10 is illustrated in accordance with a first embodiment of the present invention. The chain sprocket wrench 10 includes a handle portion 12, a bar portion 14, a tool end section 16 and an elongated flexible sprocket engaging portion 18.

The handle portion 12 includes a grip 20 that is preferably made of a material suitable for being gripped by a user's hand. For example, the grip 20 can be made of a flexible plastic or polymer material or can be made of a metallic material. The grip 20 can be a separate member that slips on to the end of the bar portion 14 or alternatively can be unitarily formed with the bar portion 14 as a single element.

The bar portion 14 is preferably made of a Ferro-magnetic material such as steel. More specifically, the bar portion 14 is made of a material that is responsive to the magnetic forces of magnetism and magnets in general. The bar portion 14 preferably extends from the handle portion 12 and may include a portion (not depicted) that extends into a hollow interior of the handle portion 12.

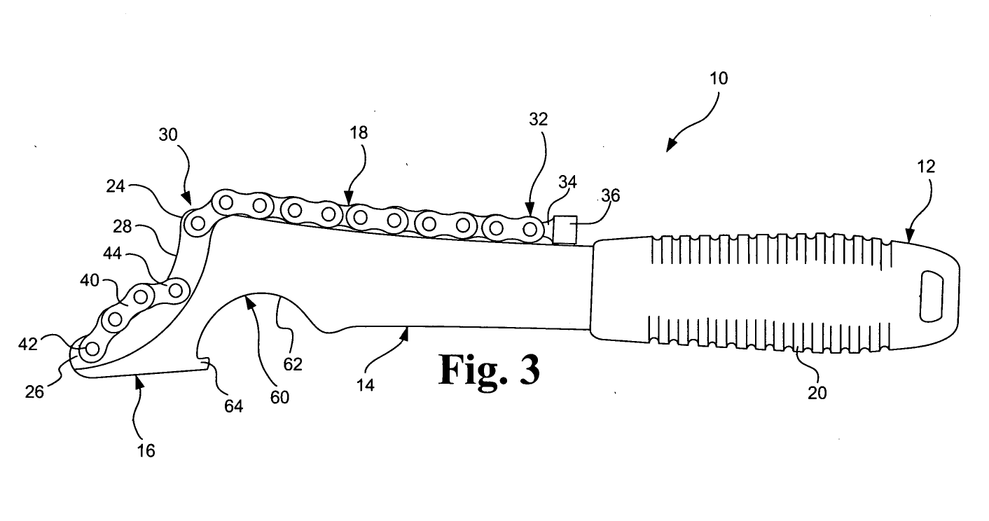

As shown in FIGS. 3, 4 and 5, the bar portion 14 includes the tool end section 16 at one end thereof. The tool end section 16 includes a first corner part 24 and a second corner part 26. The tool end section 16 is further formed with an arcuately shaped surface 28 extending between the first corner part 24 and the second corner part 26.

The sprocket engaging portion 18 is basically a multiple link chain that includes a first end 30 and a second end 32. The first end 30 of the sprocket engaging portion 18 is pivotally fixed to the first corner part 24 of the tool end section 16.

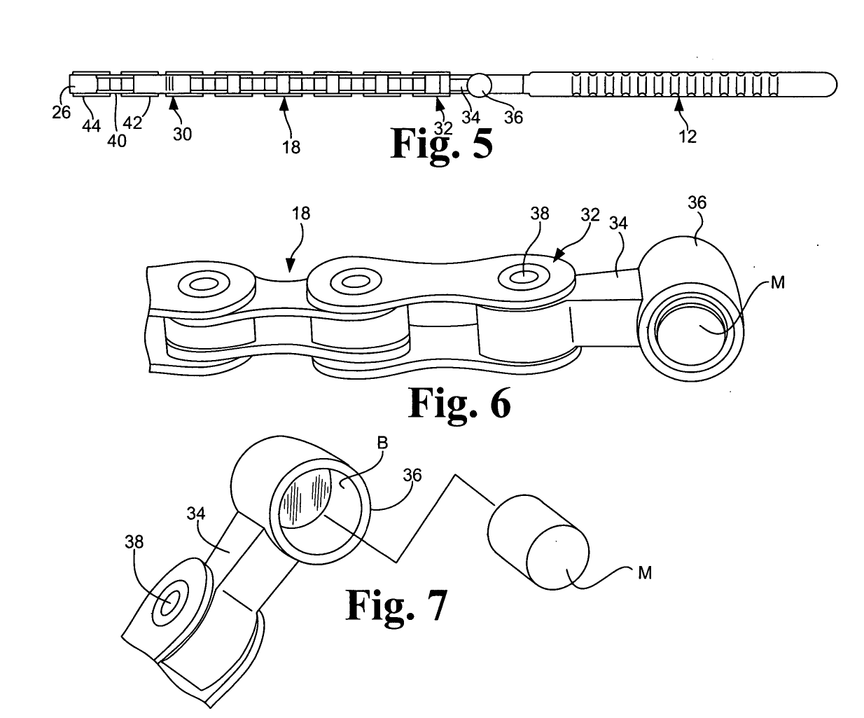

As shown more clearly in FIG. 6, the second end 32 of the sprocket engaging portion 18 includes an end link 34 that includes a magnet holder 36. The end link 34 is fixed to the second end 32 of the sprocket engaging portion 18 by a pin 38.

As shown more clearly in FIG. 7, the magnet holder 36 includes blind bore B that provides the magnet holder 36 with a closed end and a cup-like configuration. A magnet M is disposed within the blind bore B of the magnet holder 36 and is retained therein by any of a variety of means. For example, the magnet holder 36 can be crimped or deformed slightly to hold the magnet M in position. Alternatively the magnet M can be retained within the magnet holder 36 by a fastener (not shown) or bonding agent, such as an adhesive material. Since the magnet M is disposed within the blind bore B (which has a closed end), the magnet is not visible in FIG. 5.

As shown in FIG. 3, the tool end section 16 also includes a second multiple link chain 40 having a first link end 42 fixed to the second corner part 26 of the tool end section 16 and a second link end 44 fixed to a central section of the arcuately shaped surface 28. The tool end section 16 is also formed with a rigid wrench section 60 that is spaced apart from the arcuately shaped surface 28 and the sprocket engaging portion 18. The rigid wrench section 60 includes a semi-circular shape indentation 62 and a projection 64 that extends toward the handle portion 12 from one end of the semi-circular shaped indentation 62.

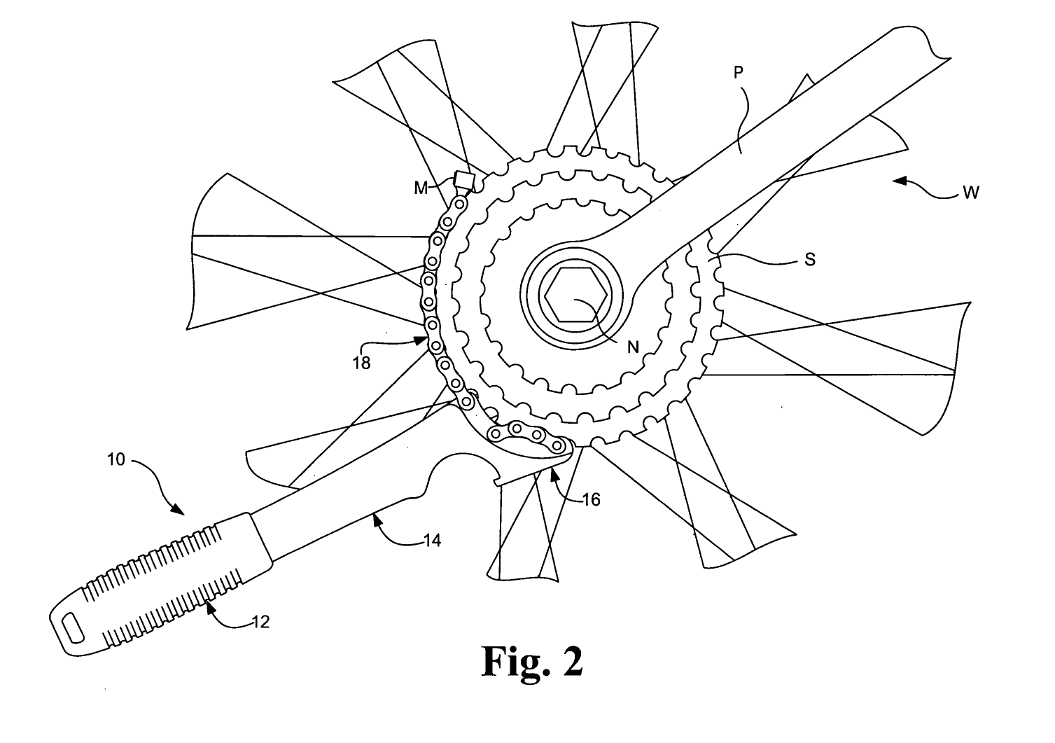

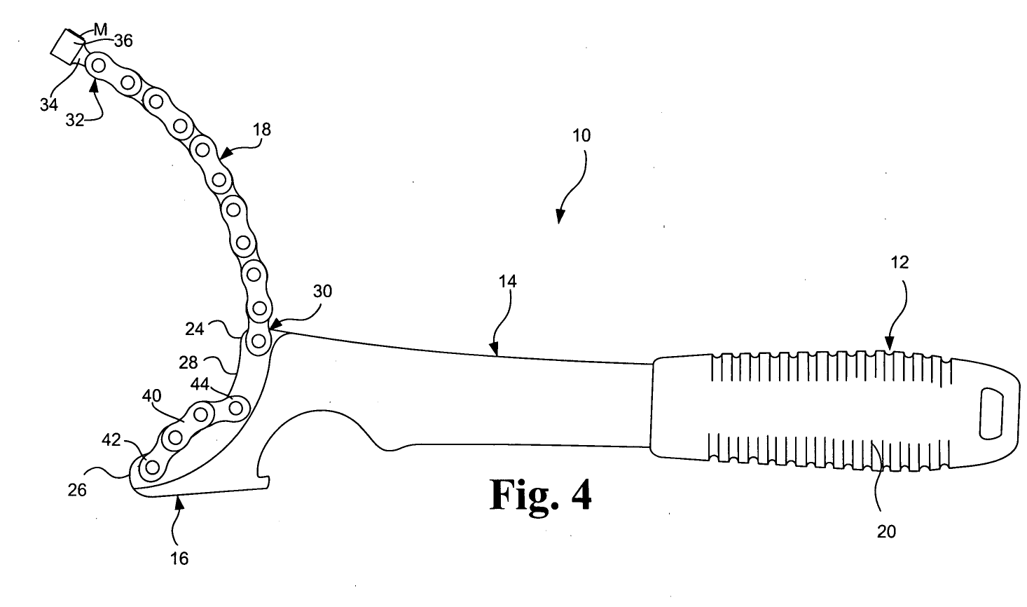

As shown in FIGS. 3 and 4, the sprocket engaging portion 18 is moveable from a tool storage orientation (FIG. 3) to a tool usage orientation (FIG. 4). As shown in FIG. 2, with the sprocket engaging portion 18 in the tool usage orientation, the chain sprocket wrench 10 can engage a sprocket set S of a bicycle wheel hub W of a bicycle (not shown). When used in cooperation with a standard wrench P, the chain sprocket wrench 10 can apply torque to a nut N.

As shown in FIG. 3, when in the tool storage orientation, the sprocket engaging portion 18 extends along a side edge of the bar portion 14 and is retained in position by the magnetic forces of the magnet M. Specifically, the end link 34 and the magnet holder 36 are installed on the second end 43 of the multiple link chain (the sprocket engaging portion 18) such that the magnetic forces of the magnet M hold the sprocket engaging portion 18 in place against the bar portion 18 when the chain sprocket wrench 10 is not in use. However, with the chain sprocket wrench 10 in the tool usage orientation, as shown in FIG. 2, the magnet is prevented from contacting the sprocket set S because of the closed end or blind bore B of the magnet holder 36.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A chain sprocket wrench comprising:
a handle portion;
a bar portion extending from the handle portion including a tool end section; and
an elongated flexible sprocket engaging portion having a first end and a second end, the first end being fixed to the tool end section, and a magnetic part fixed to the second end of the elongated flexible sprocket engaging portion.

2. The chain sprocket wrench as set forth in claim 1, wherein
the elongated flexible sprocket engaging portion includes a multiple link chain fixedly attached to the tool end section.

3. The chain sprocket wrench as set forth in claim 2, wherein
the magnetic part is fixedly coupled to an end link of the multiple link chain.

4. The chain sprocket wrench as set forth in claim 3, wherein
the magnetic part is fixedly coupled to the end link by a link pin.

5. The chain sprocket wrench as set forth in claim 2, wherein
the magnetic part includes a magnet holder having a blind bore with a magnet disposed in the blind bore of the magnet holder.

6. The chain sprocket wrench as set forth in claim 2, wherein
the tool end section includes a second multiple link chain having first and second ends fixed to spaced apart locations of the tool end section.

7. The chain sprocket wrench as set forth in claim 1, wherein
the magnetic part includes a magnet holder having a blind bore with a magnet disposed in the blind bore of the magnet holder.
